(19) United States
(12) Patent Application Publication
(10) Pub. No.: US 2016/0288978 A1
(43) Pub. Date: Oct. 6, 2016

(54) SEALABLE PACKAGE AND PRODUCTION THEREOF

(71) Applicant: BILLERUDKORSNÄS AB, Solna (SE)

(72) Inventor: Peter Bergström, Norrköping (SE)

(21) Appl. No.: 15/035,318

(22) PCT Filed: Nov. 26, 2014
(86) PCT No.: PCT/EP2014/075622

§ 371 Date: May 9, 2016

(30) Foreign Application Priority Data
Dec. 4, 2013 (EP) 13195702.9

(51) Int. Cl. B65D 77/20; B31F 1/00; B31B 43/00; B31B 1/00; B65B 7/16; B65D 1/34

(52) U.S. Cl. CPC B65D 77/2024; B65B 7/16; B65D 1/34; B31B 43/00; B31B 1/00; B31F 1/0077; B31B 2201/223; B31B 2217/101

(57) ABSTRACT

There is provided a method of producing a package (403, 503) adapted to be sealed, comprising: a) arranging a sheet (400, 500) of stretchable paper on a cavity (401, 501) having a circumferential rim such that the sheet contacts the rim of the cavity; b) applying a pressure to the sheet such that a nip (404, 504) is obtained at the rim of the cavity; c) applying a force to the sheet, wherein the pressure of b) and the force of c) are selected such that the sheet partly slides into the cavity and partly extends within the cavity to form a package having a body portion and a rim portion formed at the nip; and d) coating a surface of the rim portion to form a surface for gas-tight sealing. A package as well as a use thereof are also provided.

### TECHNICAL FIELD

The invention relates to packages, such as trays, adapted to be sealed with a film and the production thereof.

### BACKGROUND

In many fields, it is generally desirable to replace petroleum-based plastics with a renewable material. One interesting alternative to the traditional plastics, in particular in the filed of packaging, is paper. However, paper is associated with a number of drawbacks when compared to traditional plastics. Firstly, paper is generally more permeable to gases, grease and moisture. Secondly, normal paper is considerably less stretchable than many types of plastics, which limits the depth obtainable in thermoforming or vacuum forming machines. Thirdly, when normal paper during press forming is shaped in a mould to a three-dimensional package, such as a tray, the paper creases, which results in an unaesthetic appearance. It is also difficult to seal a film to a creased surface in a gas-tight manner.

The problem of sealing a creased surface is avoided in WO 09/074721, in which a tray has a major part composed of cardboard that is shaped in a mould and a minor rim part composed of plastic that is injection moulded in the same mould. The rim part provides a smooth surface that can be sealed. In similar solution is shown in WO 03/078012, in which the rim of a tray is separately moulded in plastic and then joined with the rest of the tray.

### SUMMARY

The present inventor has realized that the methods of WO 09/074721 and WO 03/078012 are comparatively complicated and require tools not currently in use. Therefore, major investments are needed to implement the methods of these documents. Further, the plastic rim introduces a substantial amount of non-renewable paper material in the product.

The inventors have realized that the problems of the prior art may be overcome by a method of producing a package adapted to be sealed, comprising: a) arranging a sheet of stretchable paper on a cavity having a circumferential rim such that the sheet contacts the rim of the cavity; b) applying a pressure to the sheet such that a nip is obtained at the rim of the cavity; c) applying a force to the sheet, wherein the pressure of b) and the force of c) are selected such that the sheet partly slides into the cavity and partly extends within the cavity to form a package having a body portion and a rim portion formed at the nip; and d) coating a surface of the rim portion to form a surface for gas-tight sealing.

The above method enabled the provision of a previously unseen product, namely a paper package adapted to be sealed, comprising a tray- or bowl-shaped body portion and a circumferential rim portion formed from a single paper sheet, said body portion having a depth and a width and said rim portion protruding outwardly from an upper edge of the body portion such that the rim portion forms a substantially horizontal rim surface, wherein the depth to width ratio is at least 1:8 and wherein the rim surface is coated to form a surface for gas-tight sealing.

There is also provided a use of the package for packing a food product.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

FIG. 1a shows a longitudinal section view of a round paper package 100 produced with a male punch according to the present disclosure. The shape of the package 100 thus corresponds to the shape of the male punch. The package has a body portion 101 and a circumferential, flat rim portion 102. The angle “v” is 15°, which means that the release angle is 75°. The diameter and thus the width “a” of the body portion 101 is 80 mm and the depth “b” of the body portion is 30 mm, which means that the depth to width ration is 3:8. The radius R1 of the rounded edge between the side wall 103 of the body portion 101 and the rim portion 102 is 3 mm. The lower bottom radius R2 is 20 mm.

FIG. 1b shows a longitudinal section view of a round paper package 110 produced with a male punch according to the present disclosure. The shape of the package 110 thus corresponds to the shape of the male punch. The package has a body portion in and a circumferential, flat rim portion 112. The angle “v” is 15°, which means that the release angle is 75°. The width “a” of the body portion 111 is 80 mm and the depth “b” of the body portion is 20 mm, which means that the depth to width ration is 2:8. The radius R1 of the rounded edge between the side wall 113 of the body portion in and the rim portion 112 is 3 mm. The lower bottom radius R3 is 5 mm.

FIG. 2a shows a side view of a round paper package 200 produced with a male punch according to the present disclosure. The shape of the package 200 thus corresponds to the shape of the male punch. The package has a body portion 201 and a circumferential, flat rim portion 202. The release angle “w” is 75°. The width “a” of the body portion 201 is 80 mm and the depth “d” of the body portion is 11.8 mm, which means that the depth to width ration is 1:7.1. The radius R1′ of the rounded edge between the side wall 203 of the body portion 201 and the rim portion 202 is 1.8 mm. The lower bottom radius R3 is 5 mm.

FIG. 2b shows a side view of a round paper package 210 produced with a male punch according to the present disclosure. The shape of the package 210 thus corresponds to the shape of the male punch. The package has a body portion 211 and a circumferential, flat rim portion 212. The release angle “w” is 75°. The width “a” of the body portion 211 is 80 mm and the depth “e” of the body portion is 5.2 mm, which means that the depth to width ration is 1:15.4. The radius R1′ of the rounded edge between the side wall 213 of the body portion 211 and the rim portion 212 is 1.8 mm. The lower bottom radius R3 is 5 mm.

FIG. 2c shows a side view of a round paper package 220 produced with a male punch according to the present disclosure. The shape of the package 220 thus corresponds to the shape of the male punch. The package has a body portion 221 and a circumferential, flat rim portion 222. The release angle “u” is 83.9°. The width “a” of the body portion 221 is 80 mm and the depth “c” of the body portion is 20 mm, which means that the depth to width ration is 2:8. The radius R1″ of the rounded edge between the side wall 223 of the body portion 221 and the rim portion 222 is 1.7 mm. The lower bottom radius R3 is 5 mm.

FIG. 3a shows a longitudinal section view of a round paper package 300 produced with a male punch according to the present disclosure. The shape of the package 300 thus corresponds to the shape of the male punch. The package has a body portion 301 and a circumferential, flat rim portion 302. The angle “v” is 15°, which means that the release angle is 75°. The width “a” of the body portion 301 is 80 mm and the depth “c” of the body portion is 20 mm, which means that the depth to width ration is 2:8. The lower bottom radius R3 is 5 mm.

FIG. 3b shows a perspective view of the package 300 of FIG. 3a. The package has a flat, horizontal, circumferential and radially protruding rim.

FIG. 3b shows a perspective view of the package 300 of FIG. 3a turned upside down.

FIGS. 4 and 5 are longitudinal section views illustrating different methods of forming a package from a sheet 400, 500 arranged on a cavity 401, 501.

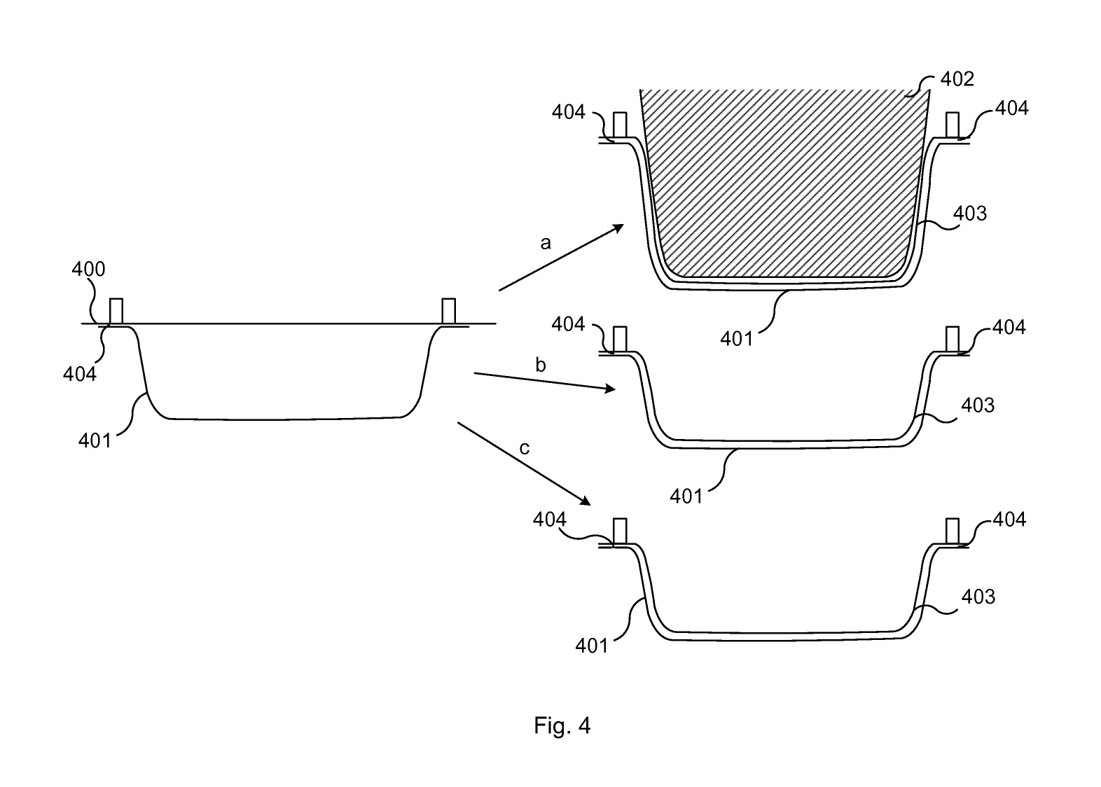

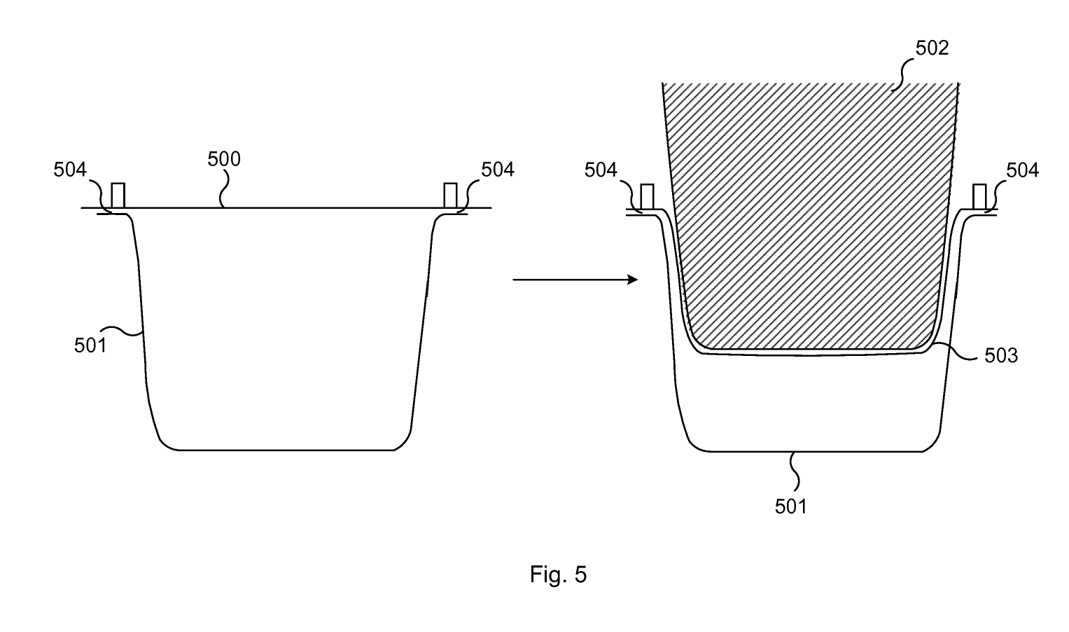

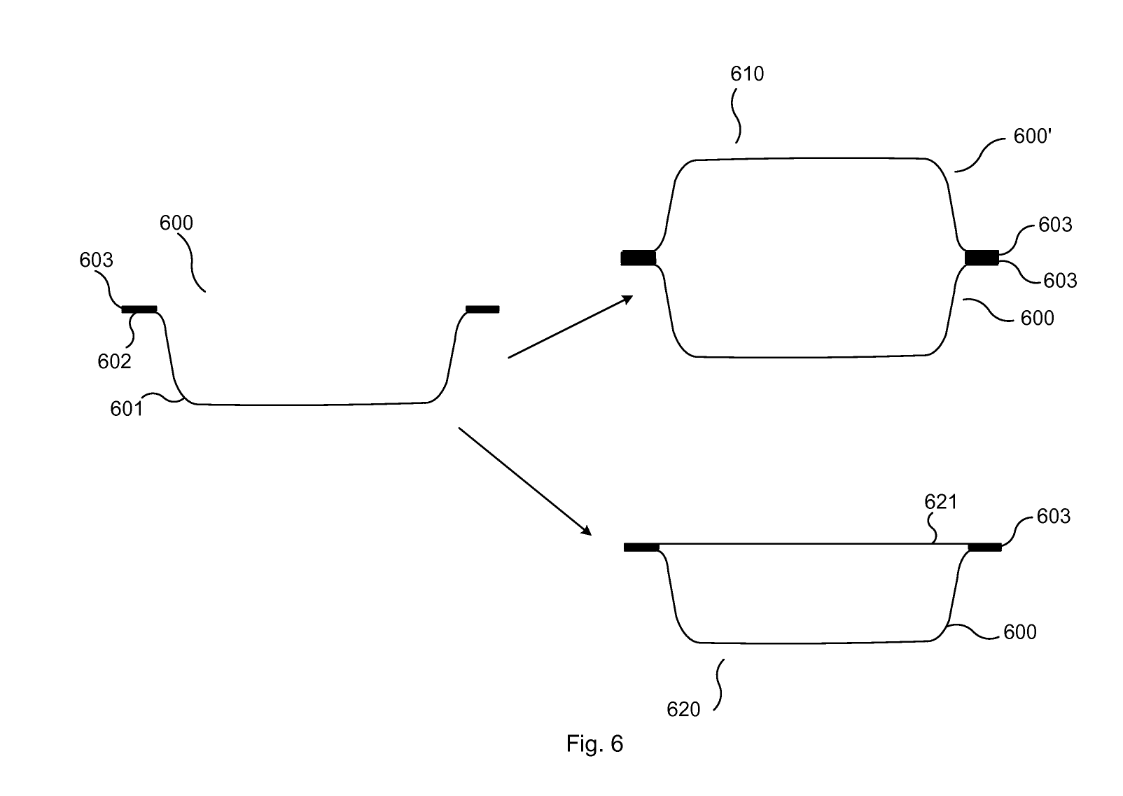

In FIG. 4a, the sheet 400 is forced into a mould cavity 401 by a male punch 402. The shape of the resulting package 403 corresponds to the shape of the mould cavity 401 and the shape of the male punch 402.

In FIG. 4b, the sheet 400 is forced into a mould cavity 401 by means of pressurized air. The shape of the resulting package 403 corresponds to the shape of the mould cavity 401.

In FIG. 4c, the sheet 400 is forced into a mould cavity 401 by means of an underpressure “vacuum” provided in the mould cavity 401. The shape of the resulting package 403 corresponds to the shape of the mould cavity 401.

In FIG. 5, the sheet 500 is forced into a cavity 501 by a male punch 502. The shape of the resulting package 503 corresponds to the shape of the male punch 502.

In FIGS. 4 and 5, a nip 404, 504 is provided at the rim of the cavity 401, 501. The pressure of the nip 404, 504 is selected such that the sheet partly slides into the cavity 401, 501 and partly extends/stretches within the cavity 401, 501.

FIG. 6 is a longitudinal section view illustrating sealing of a package 600 of the present disclosure having a rim 602 provided with a coating layer 603 on its upper surface. The result of the sealing is a clam shell capsule 610 and a film-sealed package 620, respectively.

### DETAILED DESCRIPTION

As a first aspect, there is thus provided a method of producing a package adapted to be sealed. The package may for example be a tray or a capsule. The package may for example be sealed with a film or another package (see FIG. 6). The film for sealing is often plastic, e.g. composed of polyethylene (PE). The plastic film may also comprise several layers including at least one PE layer. The film may be transparent such that the contents of the package can be seen. When the package is sealed with another package, a so called clam shell capsule may be formed. In a clam shell capsule, the two halves may be identical or mirror images of each other.

The method comprises a) arranging a sheet of stretchable paper on a cavity, such as a mould cavity. The stretchability of the paper is preferably at least 5% in both the machine direction (MD) and the cross direction (CD). For example, it may be at least 6 or 7% in both directions. In one embodiment it is at least 7% CD and at least 14% in the MD. An example of a stretchable paper suitable for the method of present invention is FibreForm® marketed by BillerudKorsnäs AB. The strechability may for example be measured according to standard ISO 1924-3. The grammage of the paper sheet may for example be 50-500 g/m², such as 100-400 g/m². A higher grammage of 200-500 g/m² may be preferred as it allows for higher clamping forces (the pressure of b)) and thus smoother rim surfaces and more evenly distributed creases on the walls of the body portion. A lower grammage of 50-200 g/m² may also be preferred as such qualities are lighter and cheaper. The paper sheet may be composed of a single layer. However, it may also be a laminate composed of a plurality of paper layers, such as two, three or four layers. The paper sheet may thus be a paperboard sheet.

The paper sheet may also be coated with one or more coating layers having one or more barrier properties. Alternatively or as a complement, a film having one or more barrier properties may be glued to the paper sheet to form a barrier layer. Examples of barrier properties include grease barrier, gas barrier and moisture barrier properties. Such barrier properties are for example of interest when foods are packaged.

The cavity has a circumferential rim. In the method, the sheet is arranged on the cavity such that it contacts the rim. Thus, during a) the sheet forms a lid on the cavity.

The method further comprises b) applying a pressure to the sheet such that a nip is obtained or formed at the rim of the cavity and c) applying a force to the sheet. The pressure of b) is often referred to as a clamping force. The force applied in c) acts on the paper inside the nip.

The pressure of b) and the force of c) are selected such that the sheet partly slides into the cavity and partly extends within the cavity. Thereby, a package 3o having a body is formed. In case of a mould cavity, the body may obtain a shape corresponding to the mould cavity during c). Further, a rim portion of the package is formed at the nip.

The pressure of b) is thus high enough to obtain a stretch of the paper in the cavity, but low enough to prevent breakage of the paper sheet.

The method also comprises d) coating a surface of the rim of the package to form a surface for gas-tight sealing. In other words, the coating provides a surface to which a film or another package can be sealed in a gas-tight manner.

The rim of the package normally has a substantially horizontal surface that is coated during d). Such a horizontal coated surface allows for e.g. film sealing in conventional machinery.

The body portion is preferably tray- or bowl-shaped. The rim portion is preferably circumferential with respect to the body portion. Further, the rim portion preferably protrudes outwardly, e.g. radially, from an upper edge of the body portion such that the rim portion forms a substantially horizontal and flat rim surface.

In one embodiment, the outer edge of the rim portion is rolled to improve the stability of the package. The tool used for b) and c) may be adapted to form such a rolled rim.

The depth to width ratio of the body portion of the package of the first aspect may for example be as described below in connection with the second aspect. In embodiments, the package of the first aspect may also have one or more of the other structural characteristics described below in connection with the second aspect.

The pressure of b) may be applied by means of a clamp that is pressed against the rim of the cavity.

The inventor has tested various pressures for b) and has found that it may for example be in the range of 1-10 bar, such as such as 1-7 bar.

The higher pressure the pressure of b), the better the surface smoothness on the rim portion and the better the distribution of micro creases. If the pressure of b) is too high, however, the paper breaks as it is prevented from sliding into the cavity.

The force of c) may for example be applied by pressing a “female tool” comprising the cavity and a “male tool” comprising a punch against each other. For example, the position of the female tool may be fixed while the male tool/punch is pressed against it. Alternatively, the position of the male tool/punch may be fixed while the female tool is pressed against it.

The shape of the body portion obtained during c) may thus correspond to the shape of the male tool. It is possible, but not necessary that the shape of the body portion also corresponds to the shape of the inside of the female cavity. This is further illustrated in FIGS. 4a and 5.

The force of c) may also be applied by means of air pressure. Alternatively, the force of c) may be a suction force. This is further illustrated in FIGS. 4b and 4c.

During b) and/or c), a lubricant may be applied to the sheet and/or the tools. The lubrication may facilitate the desired sliding through the nip and/or in the mould cavity. The lubricant is preferably food-approved. The food-approved lubricant may for example be a vegetable oil.

The coating method of d) may for example be roller coating, stamping, spraying or spreading.

Rolling coating may comprise: i) melting a coating material; ii) transferring the melted coating material to a roll; and iii) rolling the roll over the surface of the rim and thereby applying the coating material. During iii), packages may for example be conveyed under one or more rolls. Alternatively, the roll(s) may roll over one or more packages in fixed position(s).

In one embodiment, the coating of d) comprises applying a plastic, such as thermoplastic, material. The thermoplastic material may be heated (i.e. above room temperature) when applied to the surface of the rim portion. It may also be (further) heated after the application, e.g. to allow it to be evenly spread over the surface of the rim portion. Preferably, the thermoplastic material is not heated above 190° C. Accordingly, a plastic material having a sufficiently low viscosity to even out the rim surface (without leaving air pockets) at a temperature below 190° C. is selected.

An example of a specific thermoplastic material for step d) is PE.

The heated thermoplastic material may have a Brookfield viscosity of 500-5000, such as 1900-2500 mPa·s during coating.

The coating material is preferably food approved.

As a second aspect of the present disclosure, there is provided a paper package adapted to be sealed. The package comprises a tray- or bowl-shaped body portion and a circumferential rim portion formed from a single paper sheet. The body portion has a depth and a width. The rim portion protrudes outwardly from an upper edge of the body portion such that the rim portion forms a substantially horizontal rim surface. The depth to width ratio is at least 1:8. Preferably, the depth to width ratio of the body portion is at least 1:7, such as at least 1:6, 1:5, 1:4 or 1:3. Packages with a depth to width ratio of 3:8 have been produced. The width is the shortest distance between opposing upper edges of the body portion. This means that in package having a circular upper edge of the body portion, the width is the diameter of the upper edge. In a package having a rectangular upper edge of the body portion, the width is the distance between the two long sides of the upper edge.

The depth of the package of the second aspect may be at least 10 mm, such as at least 15 or 20 mm.

The rim surface of the package of the second aspect is coated to form a surface for gas-tight sealing.

The product of the second aspect is obtainable by the method of the first aspect. The embodiments and benefits of the first aspect apply to the second aspect mutatis mutandis.

In one embodiment, the inside and/or the outside of the body portion comprises a barrier coating. As understood by the skilled person, the coating on the rim surface to form a surface for gas-tight sealing is different from such a barrier coating. The barrier coating is generally provided on the paper already before the single sheet is formed into a three-dimensional package, i.e. before the body portion is formed, while the rim surface coating for gas-tight sealing is applied after the three-dimensional shape is formed. However, the rim surface coating and the barrier coating may comprise or consist of the same material, such as PE. In fact, having the same material in both coatings may be preferred as it facilitates adhesion between the two. The rim surface coating for gas-tight sealing may for example be applied on top of any barrier coating layer on the upper side of the rim portion. It is further understood that the rim surface coating for gas-tight sealing is generally applied only to the rim surface and not to other parts of the package.

Examples of barrier coatings are discussed above. As the package of the present disclosure is intended for gas-tight sealing, it is particularly advantageous if the body portion comprises a gas barrier, such as an oxygen barrier. Preferably, such an oxygen barrier is food approved, in particular if it is arranged on the inside of the body portion.

For example, the oxygen transmission (OTR) value through the body portion provided with an oxygen barrier may be less than 10 ml/m²*24 h*1 atm, such as less than 8, 5 or 3 ml/m²*24 h*1 atm.

As understood from the above, the package of the present disclosure may further comprise a film adhered to the coated rim surface such that the package is sealed. Such a film is discussed above. The package of the present disclosure may also comprise a second package sealed to it, e.g. such that a clam shell capsule is formed.

As a third aspect, there is provided a use of the package of the second aspect for packing a food product or another oxygen-sensitive food product. A sealed food package may be produced by arranging a food product in a package of the second aspect and then sealing the filled package. These two operations may be carried out in the same process line or machine.

### EXAMPLES

### 1^{st} Trial

Initially, 310 g/m² glue laminated sheet of FibreForm® was tested on a traditional press forming line for paper trays. The material worked fine. Both the package shape, the creasing appearance on the side of the tray, the rolled rim and the overall stability was considered as comparable to other board products used. However, no advantages of using FibreForm® instead of normal paper were observed.

Instead, a production line from QUALITY TOOLS for production of aluminum food containers and trays were employed. The line had a machine pressure of maximum 50 tonnes and a production speed between 40 and 90 strokes per minute. The line was reel fed and could produce aluminum pods with fairly smooth walls, flat sealing surface and a rolled rim to enhance stability. This was achieved by utilizing the stretch in the aluminum and letting it slide into the mould in a controlled manner by applying the right clamping force.

The above production line with an existing tray mould using both male and female tools was employed for 150 and 200 g/m² FibreForm® sheets and other, less stretchable, paper and board sheets.

With FibreForm®, the tray shape was almost achieved although the mould was very demanding when it came to geometry. The other paper and board sheets broke. More side wall wrinkles appeared using FibreForm compared to aluminum and the sealing surface of the rim was not as smooth.

### 2^{nd} Trial

A second trial was conducted on the QUALITY TOOL line T130 (130 tonnes press) normally is used for the production of aluminum capsules.

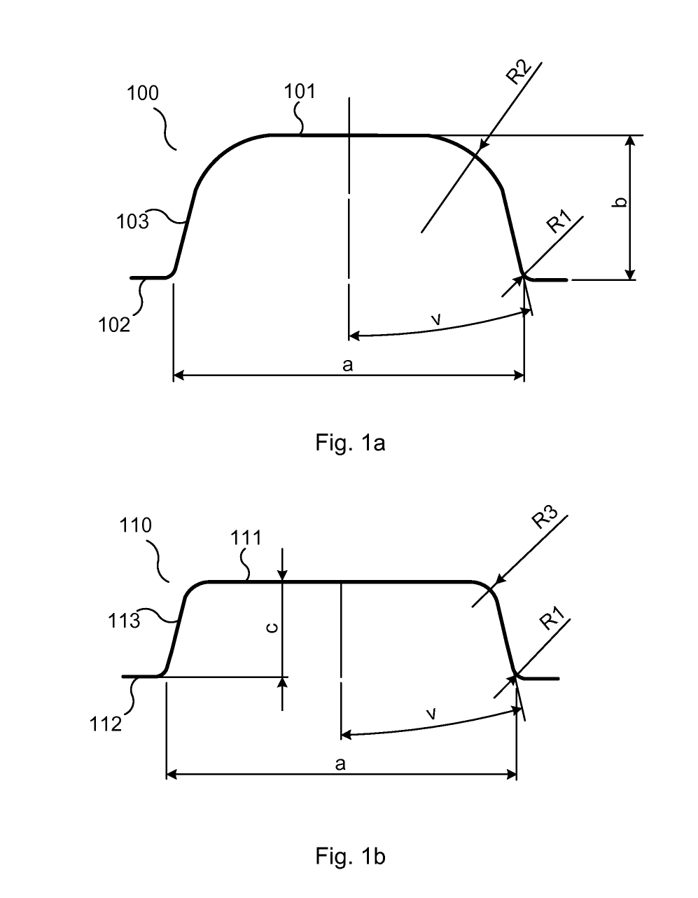

Initially, a round male tool producing the shape of FIG. 1a was used. The female tool was an open cavity. No rolling of the rim was integrated in the tool.

The following variables were used:

a) clamping force/pressure (bar) applied to the clamping frame around the male tool;
b) depth of which the male tool was pushed into the female tool, i.e. the depth of the package; and
c) oil/no oil (vegetable and food-approved oil).

The following paper materials were tested:
FibreForm® 310 g/m2 laminate;
FibreForm® 397 g/m2 laminate (150 g/m2 FibreForm®, 20 g/m2 PE, 150 g/m2 FibreForm®, 77 g/m2 PE-EVOH-PE foil);
200 g/m2 FibreForm® single ply; and
150 g/m2 FibreForm® single ply.

The following results were achieved:

For the 310 g/m2 laminate, the maximum clamping force (7.8 bar) could be used without breakage when oil was applied. The maximum depth was reached with 7.8 bar clamping pressure. The sealing rim was fairly flat, but micro creases were seen.

For the 397 g/m2 laminate, the results were approximately the same as for the 310 g/m2 laminate, but the sealing rim was slightly flatter.

For the 200 g/m2 FibreForm® (single ply), the material broke when using the same settings as for the 310 g/m2 laminate and the 397 g/m2 laminate. A reduction of the clamping pressure to 6 bar and the depth to 20 mm resulted in an unbroken package.

For the 150 g/m2 FibreForm® (single ply), no unbroken package was obtained.

The male tool was then re-milled to a reduced depth with a lower bottom radius (from 20 mm to 5 mm) to get a flatter bottom (see FIG. 1b). With the new male tools, the results were approximately the same. In other words, the reduced bottom radius did not have a negative effect on the possibility of using FibreForm®.

From the second trial, it was concluded that: it is possible to produce capsules from FiberForm® using a process designed for aluminum packages; a side wall angle of 75 degrees is reachable on a round package with a 80 mm diameter and a depth of 20-30 mm; the bottom radius is not the critical factor; and fairly flat sealing surface is obtainable, but it is questionable if it is flat enough for gas-tight sealing; and a multiple-ply or thicker material seems to work better than a thinner or single-ply material.

### 3rd Trial

Again, the Quality Tool line T130 (130 tonnes press) traditionally used for the production of aluminum capsules was employed.

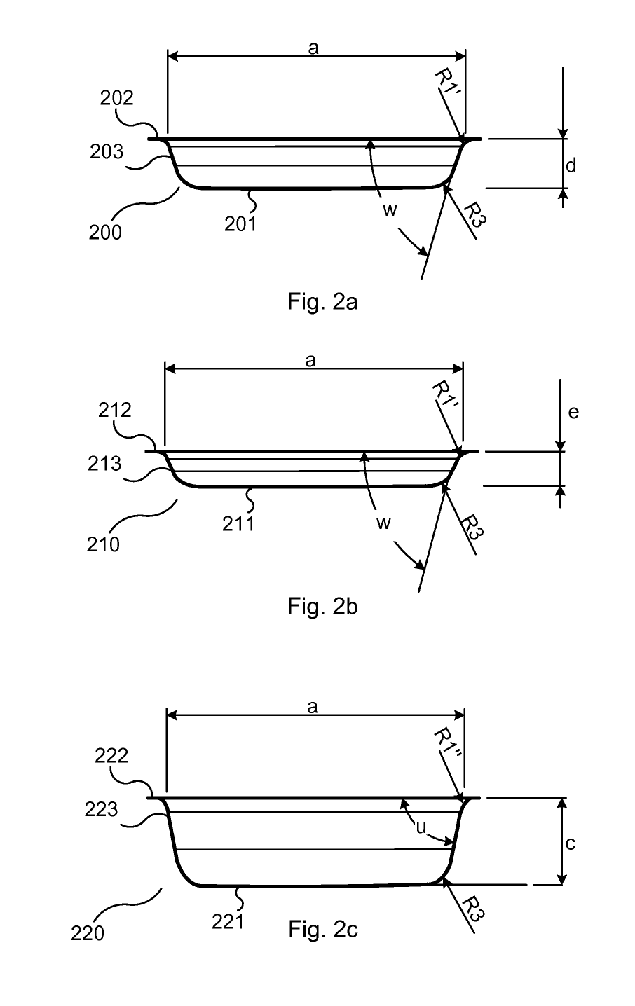

Tools i), ii) and iii) producing the packages of FIGS. 2a, 2b and 2c, respectively, were used.

For tool i), the following conditions were employed:

FibreForm® 310 g/m2 laminate maximum clamping pressure 5.5 bar;
FibreForm® 200 g/m2 single ply maximum clamping pressure 3.8 bar;
FibreForm® 80 g/m2 single ply maximum clamping pressure 1.5 bar; and
FibreForm® 150 g/m2+30 g/m2 PE maximum clamping pressure 2.3 bar.

In the third trial, vegetable oil lubricant (food approved) was used on all materials during the forming.

The above clamping pressures resulted in satisfactory forming. Higher clamping pressures resulted in more compression of the rim and a somewhat smoother rim surface. Hence, higher grammages resulted in slightly better sealing surfaces. Higher grammages also resulted in better side wall flatness. In other words, less wrinkles and waviness were obtained with the higher clamping pressures.

The 310 g/m2 material gave a packaging with smooth walls, which was almost free from wrinkles. The rim surface was almost wrinkle free.

The 200 g/m2 material resulted in a package with more side wall wrinkles and a rim with more surface wrinkles.

The 150 g/m2 material showed even more surface disturbances such as side wall and sealing rim wrinkles.

A packages was also obtainable from the 80 g/m2 material, but it had more rim surface wrinkles than the other packages.

The rim surface also showed an effect previously unseen in packages from QUALITY TOOLS' machinery; the inner part of the rim surface that was contacted by the clamping frame was significantly smother that the rest of the rim surface.

For tool ii), the following conditions were employed:

FibreForm® 200 g/m2 single ply—maximum clamping pressure 3.8 bar; and

FibreForm® 80 g/m2 single ply maximum clamping pressure 1.5 bar; and.

Despite the depth reduction the maximum clamping force remained the same, which suggest that the tensile strength of the FibreForm® material determines maximum clamping force to a much larger degree than the depth of the package.

The forming appeared to be as stable with tool ii) as with tool i).

The 200 g/m2 material resulted in a package without visible wrinkles in the side wall of the rim surface.

The 80 g/m2 material resulted in an almost wrinkle-free package.

A package was also produced using tool iii), FibreForm® 200 g/m2 single ply and a clamping force of 3.6 bar. The rim of the package was substantially wrinkled.

### 4^{th} Trial

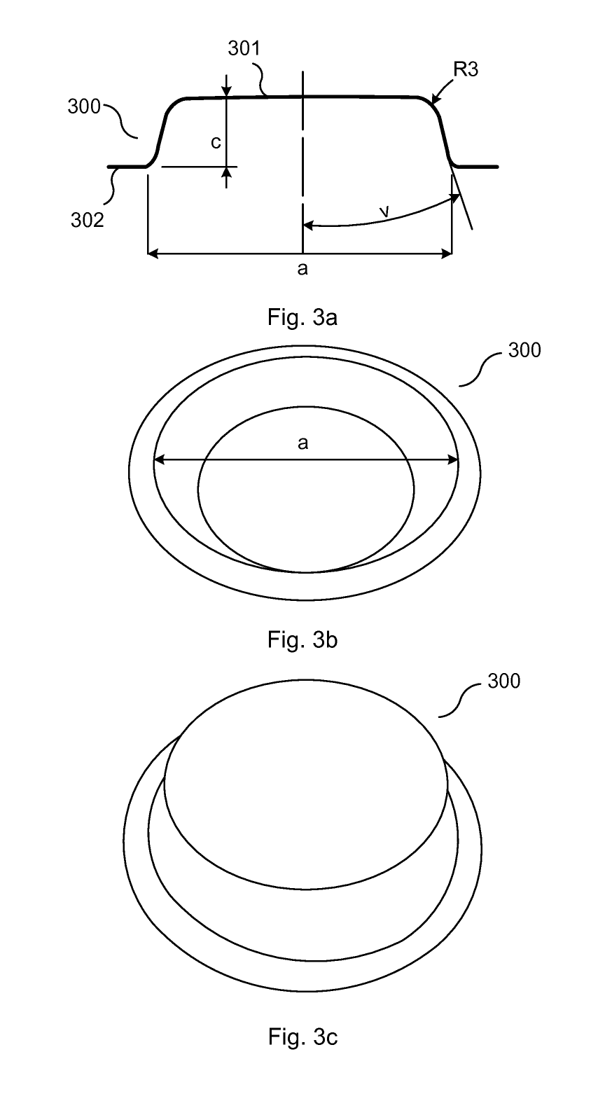

Again, the Quality Tool line T130 (130 tonnes press) traditionally used for the production of aluminum capsules was employed. The tool for producing the package of FIG. 3 was employed.

The fourth trial was carried out according to the following.

| | | | | Maximum |
|---|---|---|---|---|
| | | Plastic | | clamping |
| Sample | Construction | coating | Comment | pressure |
| 1 | 370 g/m2 FibreForm ® | PE | | 7.2 bar |
| | laminate | | | |
| | 150/20/150/50 (g/m2) | | | |
| 2 | FibreForm ® | PE | | 3.8 bar |
| | 150/30 (g/m2) | | | |
| 3 | FibreForm ® | | | 3.6 bar |
| | 150 (g/m2) | | | |
| 4 | FibreForm ® | CPET | | 5 bar |
| | 200/35 (g/m2) | | | |
| 5 | FibreForm ® laminate | | Clay coated | 6.5 bar |
| | 166C1S/20/150 (g/m2) | | and digitally | |
| | | | printed | |

The test was made by cutting out round samples and putting them on the mould after adding oil on the mould surfaces to control paper slide. Then, the maximum clamping force was tested.

Sample 1 had an almost completely smooth rim and only a few vertical marks on the side wall. The rim was rather flat without too much waviness.

For sample 2, the package quality was a bit lower than for sample 1, probably as a result of the lower clamping force, and showed some wrinkles on the rim and on the side wall. Further, the rim was wavy.

For sample 3, the package quality was about the same as for sample 2.

For sample 4, the package quality was better than for sample 2, but not as good as for sample 1. The rim had only fine wrinkles and the side wall was almost completely smooth.

Sample 5 was tested with the coated side facing inwardly and outwardly, respectively. The outcome was similar for both alternatives, with just a slightly improved rim surface when the coated side faced inwardly. No rim waviness was observed and the side wall was smooth.

### 5^{th} Trial

In food packages, a gas barrier is often required. In trays and capsules, the sealing between rim and film may therefore be critical. To obtain a gas-tight sealing, is often necessary that the sealing surface of the rim is smooth. As shown in trials one to four above, a sufficiently smooth surface is not always obtained. Microscopy examination of two packages produced according to the above was carried out. One of the packages had a comparatively wrinkly rim surface, while the other one of the packages has a comparatively smooth rim. The examination indicated that the depth of the rim surface wrinkles was down to 8 μm on the smoother package and down to 20 μm on the more wrinkled package.

Accordingly, the present inventor has realized the need for a smoother rim surface. Further, the present inventor has found that such a smooth surface may be obtained by coating the rim surface after the processing described above under trials one to four.

In the fifth trial, the food approved hot-melt adhesive Technomelt® Supra 150 Plus (Henkel) having a Brookfield viscosity of 1900-2500 mPas at 160° C. was used. The adhesive was expected to be compatible with the PE coating of the FibreForm® material.

For application of the adhesive, a glue gun (Limpistol 50.4, LimGrossen AB) was used. The opening in the nozzle had a diameter of 1.02 mm. The adhesive was heated to 175° C. in the gun.

A test package having a diameter of 80 mm and a flat and horizontal rim surface was placed on a rotating support. A single strand of adhesive was applied by means of the glue gun to the upper surface of the circumferential rim to form a single adhesive circle. A flat iron having a temperature of 175° C. was then used to spread the adhesive over the rim surface.

After cooling, a transparent top film (PE/EVOH/PE) was placed on the package. The film was sealed to the rim surface by heating using a flat iron at a temperature of 120° C. The sealing was satisfactory.

An uneven rim surface of a tray was also coated according to the above. Visual inspection revealed that the coating successfully penetrated the creases and provided a smooth surface.

FIG. 6 illustrates a package 600, that may be produced according to the above, comprising a body portion 601 and a rim portion 602 provided with a coating layer 603 for gas-tight sealing. The package 600 is sealed with another package 600′ to form a clam shell capsule 610. Alternatively, the package 600 is sealed with a film 621 to form a film-sealed package.

As understood by the skilled person, a more efficient method of applying the coating to the rim surface may be employed in an industrial setting.

1. A method of producing a package adapted to be sealed, comprising:
a) arranging a sheet of stretchable paper on a cavity having a circumferential rim such that the sheet contacts the rim of the cavity;
b) applying a pressure to the sheet such that a nip is obtained at the rim of the cavity;
c) applying a force to the sheet, wherein the pressure of b) and the force of c) are selected such that the sheet partly slides into the cavity and partly extends within the cavity to form a package having a body portion and a rim portion formed at the nip; and
d) coating a surface of the rim portion of the package formed in step c) to form a surface for gas-tight sealing.

2. The method according to claim 1, wherein the force of c) is applied by means of air pressure or a punch.

3. The method according to claim 1, wherein the force of c) is a suction force.

4. The method according to claim 1, wherein the pressure of b) is an overpressure of 1-10 bar.

5. The method according to claim 1, wherein the coating of d) comprises applying a plastic material.

6. (canceled)

7. The method according to claim 1, wherein the package is a tray package or capsule.

8. The method according to claim 1, wherein the rim portion is a radially outwardly protruding circumferential flange.

9. The method according to claim 1, wherein the rim surface is a substantially planar surface.

10. The method according to claim 1, wherein the coating of d) comprises roller coating, stamping, spraying or spreading.

11. A paper package adapted to be sealed, comprising a tray- or bowl-shaped body portion and a circumferential rim portion formed from a single sheet of stretchable paper, said body portion having a depth and a width and said rim portion protruding radially outwardly from an upper edge of the body portion such that the rim portion forms a substantially planar rim surface, wherein the depth to width ratio is at least 1:3 and wherein the rim surface is coated to form a surface for gas-tight sealing.

12. The package according to claim 11, wherein the depth to width ratio is at least 3:8.

13. The package according to claim 11, wherein the inside and/or the outside of the body portion comprises an oxygen barrier coating and the oxygen transmission value through the body portion is less than 10 ml/m2*24 h*1 atm.

14. The package according to claim 11, further comprising a film adhered to the coated rim surface such that the package is sealed.

15. A method of packing a food product comprising using a package according to claim 11.

16. The method according to claim 1, wherein the pressure of b) is an overpressure of 1-7 bar.

17. The method according to claim 5, wherein the coating of d) comprises applying a thermoplastic material.

18. The method according to claim 17, wherein the thermoplastic material is heated.
